(19) United States
(12) Patent Application Publication
(10) Pub. No.: US 2007/0130487 A1
(43) Pub. Date: Jun. 7, 2007

(54) Processing of an interruption to a communication connection between a domestic appliance and a controller in a local network

(75) Inventors: Theo Buchner, Neustadt (DE); Horst Werkmann, Pfaffenhofen/Ilm (DE)

Correspondence Address: LERNER GREENBERG STEMER LLP, P O BOX 2480, HOLLYWOOD, FL, 33022-2480, US

(73) Assignee: BSH BOSCH UND SIEMENS HAUSGERATE GMBH

(21) Appl. No.: 10/579,950

(22) PCT Filed: Nov. 22, 2004
(86) PCT No.: PCT/EP04/53045

§ 371 Date: Nov. 7, 2006

(30) Foreign Application Priority Data
Nov. 21, 2003 (DE) 103 54 498.4

(51) Int. Cl. G06F 11/00

(52) U.S. Cl. 714/4

(57) ABSTRACT

A method and a device determine an interruption state of a communication connection between a domestic appliance and a controller. The communication connection is between the domestic appliance, optionally connected in a local area network to further domestic appliances, to a bus line configuration, including a bus line controller, by which information about the status of the domestic appliance is transmitted to the bus line controller. A fixed criterion of the domestic appliance is repeatedly requested over time by the bus line controller. On an established communication connection, a reply signal is transmitted. Should no reply signal be transmitted, an interruption in the communication connection is assumed. A search operation is carried out until a reply is obtained from the domestic appliance and than updated status information is transmitted to the bus line controller.

The invention relates to a method and a device for determining an interruption of a communication connection between a domestic appliance connected in a local area network to which further domestic appliances are optionally connected, to a bus line arrangement comprising a bus line controller, and the relevant bus line controller to which information about its respective appliance status is transmitted by the relevant domestic appliance, and for the continuation of such transmissions on re-establishing the communication connection after eliminating the interruption, wherein the relevant domestic appliance is allocated a unique address for its identification in the local area network.

A method and a device for transmitting information signals or data between a domestic appliance and a bus line controller connected to a bus line arrangement have already been described elsewhere (see, for example, DE 100 56 492 A1 and DE 103 13 360 A1). However, no further details are known in the relevant context relating to the determination of interruptions of communication connections from and to the domestic appliances and relating to measures for resuming the transmission of information signals and data from and to these domestic appliances after eliminating the interruptions.

Interruptions of communication connections from and to domestic appliances connected to a local area network pf a bus line arrangement comprising a bus line controller can be caused by short-term faults or by building modification or by long-term faults. When information or data on the respective appliance status is to be transmitted independently in the relevant local area network by the domestic appliances contained in said network without a separate request (see, for example, DE 102 60 143 A1), in order to keep the loading of the local area network as low as possible, in the event of the occurrence of an interruption of the respective communication connection, no notification of the relevant interruptions is available to the device to which the relevant information or data is transmitted, that is usually the afore-mentioned bus line controller connected to the bus line arrangement to which the afore-mentioned local area network is connected. In principle, it would be possible to transmit the information or data from the respective domestic appliance in response to corresponding requests which were to be directed to the relevant domestic appliances. However, this would result in considerable undesirable loading of the afore-mentioned local area network and the bus line arrangement belonging thereto. Thus, such a measure for determining interruptions of communication connections from and to domestic appliances does not come into consideration.

It is thus the object of the invention to provide a way whereby in a method and a device of the type specified initially, an interruption of a communication connection between a domestic appliance which is connected to a bus line arrangement comprising a bus line controller in a local area network, and the relevant bus line controller can be determined and in addition, transmissions of information from and to the relevant domestic appliance can be resumed when the communication connection is re-established after the relevant interruption in a simple manner and with a particularly low loading of the local area network and the bus line arrangement pertaining thereto.

The object indicated hereinbefore is solved in a method of the type described initially according to the invention whereby when said information is transmitted merely in the form of alteration information from said one domestic appliance on its respective appliance status to the bus line controller, a certain fixed criterion of said domestic appliance is repeatedly requested over time by the bus line controller whereupon if the communication connection exists with the relevant domestic appliance, a response signal is transmitted therefrom to the bus line controller,

the absence of such a reply signal is considered to be an interruption of the communication connection with the relevant domestic appliance,

whereupon a search operation for the relevant domestic appliance is carried out by the bus line controller until a reply signal is obtained from said appliance again,

and then information corresponding to the then valid current status of the relevant domestic appliance is transmitted to the bus line controller.

The invention has the advantage that firstly, the loading of the local area network together with the bus line arrangement can be kept low as a result of the fact that only alteration information on its respective status is transmitted by the relevant domestic appliance to the bus line controller and secondly, a relatively low loading of the relevant local area network and the bus line arrangement can be achieved in order to determine the existence of an interruption of the communication connection with the relevant domestic appliance and to resume transmissions of information from and to the domestic appliance concerned. Since the bus line controller merely requests a certain fixed criterion of said domestic appliance repeatedly over time, the extent of loading of the local area network and the bus line arrangement can be kept relatively low since different appliance statuses of the relevant domestic appliance are not requested which would mean a more elaborate request procedure and therefore a higher loading of the local area network and the bus line arrangement. Also, the search operation for the relevant domestic appliance within the local area network carried out in the absence of a reply signal from the domestic appliance does not involve any very substantial loading of the relevant local area network and the bus line arrangement. In the course of the relevant search operation, the bus line controller can transmit a certain interrogation signal which is only answered by that domestic appliance to which the communication connection was interrupted. The relevant interrogation signal, which can optionally be the same as that with which the bus line controller repeatedly requests a certain fixed criterion of said domestic appliance over time, can be recognised by the relevant domestic appliance whose communication connection was interrupted, for example, from the circumstance that this interrogation signal could not be received during a specified time interval in the domestic appliance.

Finally, the bus line controller can then be synchronised to the current states of the domestic appliance being considered by information corresponding to the current status of the relevant domestic appliance at this time being transmitted to said controller.

Preferably both the requesting of the specific fixed criterion of said domestic appliance and said search operation are both carried out cyclically, for example, every minute. Preferably, the respective appliance principal status, that whether the relevant domestic appliance is switched on or off is requested as the specific fixed criterion of said domestic appliance. This means a particularly low interrogation loading of the local area network and the relevant bus line arrangement since merely an ON status or OFF status is requested and a corresponding reply signal (for example, 1 or 0) is to be transmitted.

Since it can be expected that an interruption of the communication connection between the afore-mentioned domestic appliance and the bus line controller can be a longer-term interruption which, for example, lasts several hours or days and in addition, one or more further domestic appliances can be connected in the meantime to the local area network to which the relevant domestic appliance is connected, it can arise that in the course of a registration procedure for registering the respective further domestic appliance in the local area network and therefore on the bus line arrangement, an address is issued which had previously been allocated to the domestic appliance whose communication connection is now interrupted. Such a registration procedure is given, for example, in the other citation already mentioned (DE 103 13 360 A1) . In this case, it is advantageous if the information relating to the current status of said domestic appliance is only transmitted after the relevant domestic appliance has been allocated a unique address at this time by a registration procedure in the local area network. As a result, uniqueness is ensured with regard to the addressing of the domestic appliances belonging to the afore-mentioned local area network.

Secondly, the object specified above is solved in a device of the type specified initially according to the invention whereby when said information is transmitted merely in the form of alteration information from said one domestic appliance on its respective appliance status to the bus line controller, the bus line controller repeatedly requests over time a certain fixed criterion of said domestic appliance, if the communication connection exists with the relevant domestic appliance, said bus line controller receives a reply signal from said appliance in each case,

said bus line controller comprises an evaluation device which, in the absence of a reply signal, provides a message signal indicating an interruption of the communication connection to the relevant domestic appliance

and the bus line controller is further constructed so that in response to said message signal, it carries out a search operation for the relevant domestic appliance until a reply signal is obtained from said appliance again,

and it then allows information corresponding to the then valid current appliance status of the domestic appliance to be received.

This results in the advantage of an overall particularly low expenditure on apparatus to keep the loading of the local area network and the bus line arrangement as low as possible.

More appropriately, the bus line controller is a controller which cyclically requests said certain fixed criterion of the relevant domestic appliance and also cyclically conducts said search operation. A particularly low expenditure on control is hereby achieved.

Preferably, the relevant bus line controller is a controller which cyclically repeatedly requests the principal status of said domestic appliance. Such a controller advantageously causes a particularly low loading of the local area network and the bus line arrangement pertaining thereto.

In order that the afore-mentioned registration procedure can be carried. out with a particularly low expenditure, the bus line controller is more appropriately designed such that before receiving said current status of the relevant household appliance, it includes this domestic appliance in a registration procedure by which means said relevant domestic appliance obtains a unique address at this time in the local area network by which it can be reached in the local area network.

The invention is explained in detail hereinafter with reference to an exemplary embodiment.

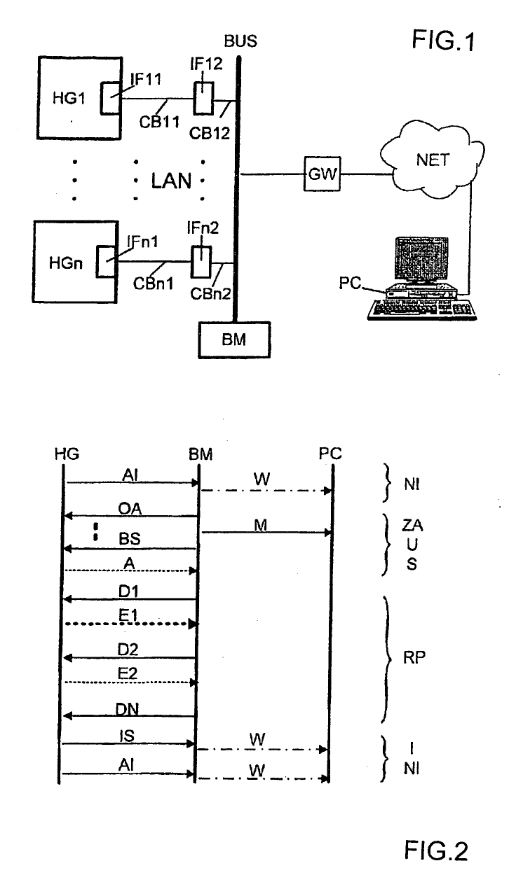

FIG. 1 is a schematic diagram showing a local area network containing a plurality of domestic appliances with a bus line arrangement comprising a bus line controller, to which a further communication network is connected via an interface device, to which for example a participant station formed by a personal computer is connected.

FIG. 2 is a schematic diagram illustrating the sequence of different processes in connection with a domestic appliance shown in FIG. 1.

FIG. 1 is a schematic diagram showing a plurality of domestic appliances HG1 to HGn which can be different domestic appliances of the same household or different households such as washing machines, electric cookers, dishwashers, microwaves, refrigerators, fume extraction hoods, air conditioning plants, coffee machines, vacuum cleaners, cooking hobs, freezers etc. The relevant domestic appliances HG1 to HGn are connected by means of their relevant interface devices IF11 to IFn1 using directionally operated connecting lines or connecting leads CB11 to CBn1 to further interface devices. IF12 to IFn2 which are connected by means of corresponding connecting lines CB12 to CBn2 to a bus line arrangement BUS. All these connecting lines and the bus line arrangement form a local area network LAN. At this point, it should be noted that the local area network LAN can be a wireless network (radio network) or a wired network, for example, the usual power supply network of the domestic appliances.

A bus line controller BM designated as a bus master is connected to the afore-mentioned bus line arrangement BUS. In the present case, this bus line controller BM is the communication partner for the domestic appliances HG1 to HGn. Transmissions of information take place between the domestic appliances HG1 to HGn and the bus line controller BM as part of communications. Thus, requests are directed to the individual domestic appliances HG1 to HGn by the bus line controller BM and information signals or data are transmitted to the bus line controller in response to these or without these in the domestic appliances HG1 to HGn. In the latter case, appliance status data, for example, more accurately alteration information are transmitted from the individual domestic appliances HG1 to HGn to the bus line controller BM.

With regard to the bus line controller BM it should be noted here that this can be a bus line controller used to operate bus line arrangements for example. In addition, the relevant bus line controller can be formed together with the interface devices IF12 to IFn2 by so-called bus couplers as has already been described elsewhere (see DE 103 13 360 A1).

A further network NET is connected to the bus line arrangement BUS shown in FIG. 1 by means of an access device GW known as gateway in English. In the present case, connected to the further network NET for example is a personal computer PC as a communication station of a user of the domestic appliance or appliances HG1 to HGn. The further network NET can, for example, comprise the internet or a separate local area network such as an ethernet or the GSM network for example. Furthermore, further communication stations can be connected to the relevant further network NET which are allocated to various domestic appliances. In addition, a plurality of further networks with relevant communication stations can be connected to the bus line arrangement BUS by means of their own access devices.

The information made available by domestic appliances HG1 to HGn of the bus line controller BM is supplied by said controller via the intercommunication gateway GW and the further network NET to the personal computer PC for the corresponding display of information.

In the present case the device shown schematically in FIG. 1 operates in such a manner that in each case only information signals or data relating the status alterations of the respective appliance status are transmitted to the bus line controller BM by the individual domestic appliances HG1 to HGn. As a result, the data loading on the bus line arrangement BUS is kept relatively low. Corresponding alteration information signals or data are provided by the bus line controller BM either on separate request or specifically to the particular user in question or in the present case, their personal computer such as the personal computer PC via the intercommunication gateway GW and the further network NET.

If a fault or an interruption, hereinafter called interruption for short, occurs in the connecting lines CB11, CB12 or Cbn1, CbN2 connecting the respective domestic appliance HG1 to HGn to the bus line arrangement BUS or the bus line arrangement BUS itself in the configuration explained hereinbefore, neither the bus line controller BM nor the user of the personal computer PC can identify a fault therefrom. In order to solve this problem, the present invention has been created, which is now explained in detail using the schematic diagram in FIG. 2.

Before the present invention is discussed in detail, it should first briefly be explained how the device shown in FIG. 1 operates in normal mode.

After a domestic appliance has been connected to the bus line arrangement BUS, this domestic appliance is first allocated a unique domestic address by the bus line controller BM in the course of its registration within the local area network LAN comprising the bus line arrangement BUS. The address allocation for this purpose can take place, for example, as explained in detail further below.

After the relevant domestic appliances has been registered and thus a unique domestic appliance address has been allocated, various information or data relating to the domestic appliance, such as the type of domestic appliance, e.g. washing machine, the embodiment of the relevant type of domestic appliance, the appliance number of the domestic appliance etc. are all transmitted to the bus line controller BM. All this information or data is then retained in the bus line controller BM for various tasks, such as for example, for carrying out remote inquiries or remote diagnoses relating to the relevant domestic appliance.

FIG. 2 shows three perpendicular bar lines which symbolise a domestic appliance, the bus line controller BM shown in FIG. 1 and the personal computer PC also shown in FIG. 1. Arrow lines plotted between the relevant bar lines each designate processes taking place or delivered messages.

A region with normal information transmission designated as NI is illustrated in the upper area of FIG. 2 wherein merely alteration information AI on the respective appliance status of the relevant domestic appliance HG is transmitted from the relevant domestic appliance HG to the bus line controller BM. This alteration information is optionally passed on W to the personal computer PC.

In the second region in FIG. 2 considered from above, processes are illustrated which take place in addition to the normal information transmission NI between the relevant domestic appliance HG and the bus line controller MB. According to these additional processes, the bus line controller BM makes a cyclic request ZA for a certain fixed criterion from the domestic appliance HG, especially for the respective appliance principal status (ON, OFF). If such a cyclic request remains unanswered OA, this is assessed in the bus line controller MB as an interruption U of the communication connection with the relevant domestic appliance HG and specifically, for example, by a separate evaluation device which delivers a message. Thereupon, a corresponding message M can be optionally delivered to the relevant personal computer PC, according to which the relevant domestic appliance HG is “offline” so to speak, that is an interruption U to this domestic appliance HG exists.

Thereupon, a search S for the relevant domestic appliance HG takes place in the local area network LAN shown in FIG. 1. This search which can take place cyclically like the previously mentioned inquiry, every minute for example, is continued until there is a reply A from the relevant domestic appliance HG. At this point, it should be noted that a general inquiry signal BS (broadcast signal in English) is sent out by the bus line controller BM in the course of the afore-mentioned search whereby, for example, by including the appliance number of the domestic appliance HG which has “been lost” to a certain extent, this appliance is searched for quite specifically and until the searched-for domestic appliance HG answers after the interruption U has been lifted.

Another possibility for searching S and determining the “lost” domestic appliance consists in the relevant domestic appliance HG, which has not received any more inquiry signals since the interruption U of its communication connection, delivering a reply signal merely from this finding in response to the incoming general inquiry signal after the relevant interruption has been lifted, which reply signal in turn lets the bus line controller BM know that the previously “lost” domestic appliance HG has been found again.

In response to the processes explained hereinbefore, a registration procedure RP then runs in the device shown in FIG. 1 as illustrated in the third region from above in FIG. 2. In the course of this registration procedure RP, an address is allocated by which the unique address at this time is allocated to the domestic appliance HG. As mentioned above, a unique address is allocated to each domestic appliance in the local area network LAN. If such a domestic appliance can no longer be reached as a result of an interruption or fault of its communication connection with the relevant local area network LAN, it can arise that the address allocated to this domestic appliance is allocated in the meantime to another domestic appliance which is connected to the relevant local area network as a new domestic appliance. For this reason, according to the present invention a current address at this time is now allocated as part of the afore-mentioned registration procedure RP to the domestic appliance HG whose communication connection was previously interrupted or disturbed. The associated address allocation can take place as has already been described in the other citation mentioned initially (DE 103 13 360 A1).

In the course of this address allocation, the bus line controller BM generates addresses and delivers these via the bus line arrangement BUS. If such an address D1, D2 has already been allocated for a domestic appliance, this is notified to the bus line controller BM to a certain extent as “objection” E1, E2. Thereupon, the relevant bus line controller BM tries with a different address DN until a “positive” answer is finally present, that is no “objection” is raised. The address is then allocated to the domestic appliance HG in the network LAN as the domestic address under which the relevant domestic appliance can be uniquely reached in the local area network LAN. This address allocation thus corresponds to an address searching procedure which is described as trial and error in English. At this point it should be noted that the allocation of addresses can not only take place in the manner explained previously but can also proceed in a completely different manner. For example, the relevant allocation of addresses and therefore the registration of the individual domestic appliances can take place, for example, using a central address allocation device connected to the bus line arrangement BUS.

In FIG. 2 two attempts at allocation of addresses with the respective address being declined are indicated in the region designated as registration procedure. Only the third attempt at allocating an address is successful without being declined so that the domestic appliance is now allocated an address which uniquely designates it in the local area network LAN.

After the interruption U of the communication connection with the relevant domestic appliance HG has been lifted and the relevant domestic appliance has been allocated a current address DN, the information status I in the bus line controller BM or in the bus master is now updated and a normal information transmission NI takes place from which the upper part of FIG. 2 starts. These relationships shown in the lowest region in FIG. 2 initially mean an updating and therefore synchronising of the information status of the bus line controller BM by the domestic appliance HG with optional further transmission W of the relevant updating information IS to the personal computer PC and then the subsequent transmission of alteration information AI from the relevant domestic appliance HG to the bus line controller BM and optionally the further transmission W of this information to the personal computer PC. This means that the bus line controller BM only allows information to be received again by the relevant domestic appliance HG after the previous registration procedure RP.

The cyclic interrogation ZA of the relevant domestic appliance HG is now received again.

Thus, after an interruption U or fault of a communication connection with the domestic appliance HG has been lifted, a new application and synchronisation takes place between this domestic appliance HG and the bus line controller BM. Thus, the local area network LAN between the domestic appliance HG and the bus line controller BM therefore automatically recovers to a certain extent from the afore-mentioned interruption U or fault; self-healing therefore takes place in relation to the interruption U or fault.

By means of the present invention, the user using the personal computer according to FIG. 1 can therefore be informed immediately about the actual status of the domestic appliance or the domestic appliances by the bus line controller BM. This means that the user can “trust” the system since he is currently informed about its actual status. The entire system responds dynamically to communication faults or blockades and regenerates automatically without interaction of the respective user when the fault or interruption U is no longer present. If the respective user does not call upon the system during the time when a communication interruption exists, the “blackout” remains invisible to him. This results in high customer satisfaction since a high system availability is provided.

1-10. (canceled)

11. A method for determining an interruption of a communication connection between a domestic appliance connected in a local area network to which further domestic appliances are connected, to a bus line configuration having a bus line controller, which comprises the steps of:
transmitting information to the bus line controller about an appliance status of the domestic appliance;
allocating the domestic appliance a unique address for identification of the domestic appliance in the local area network;
repeatedly requesting a specific fixed criterion of the domestic appliance over time by the bus line controller if the information includes change information on the appliance status;
transmitting a reply signal from the domestic appliance to the bus line controller if the communication connection exists between the domestic appliance and the bus line controller, an absence of the reply signal being interpreted as an interruption of the communication connection with the domestic appliance resulting in a performance of a search operation for the domestic appliance, the search operation including the steps of:
transmitting a general interrogation signal from the bus line controller to the domestic appliance until the reply signal is received from the domestic appliance again; and
subsequently transmitting further information corresponding to a then valid current status of the domestic appliance to the bus line controller.

12. The method according to claim 11, which further comprises requesting the specific fixed criterion of the domestic appliance cyclically.

13. The method according to claim 11, wherein the appliance status is the specific fixed criterion of the domestic appliance.

14. The method according to claim 11, which further comprises carrying out the search operation cyclically.

15. The method according to claim 11, which further comprises transmitting a current status of the domestic appliance to the bus line controller only after the domestic appliance has been allocated the unique address in the local area network via a registration procedure.

16. A device for determining an interruption of a communication connection between a domestic appliance connected in a local area network to which further domestic appliances are connected, the device comprising:
a bus line configuration having a bus line controller, said bus line controller receiving information pertaining to an appliance status of the domestic appliance;
said bus line controller programmed to allocate a unique address for identifying the domestic appliance in the local area network;
said bus line controller programmed to repeatedly request over time a specified fixed criterion of the domestic appliance when the information transmitted contains change information from the domestic appliance regarding the appliance status;
said bus line controller configured such that in a presence of the communication connection to the domestic appliance, said bus line controller receiving a reply signal from the domestic appliance; and
said bus line controller containing an evaluation device configured such that, in an absence of the reply signal, said evaluation device providing a message signal indicating an interruption of the communication connection to the domestic appliance, and said bus line controller being constructed so that in response to the message signal, said bus line controller carries out a search operation for the domestic appliance wherein a general interrogation signal is transmitted until the reply signal is obtained from the domestic appliance again, and said bus line controller is further constructed such that said bus line controller then allows information corresponding to a then valid current appliance status to be received.

17. The device according to claim 16, wherein said bus line controller is a controller which cyclically requests the specified fixed criterion of the domestic appliance.

18. The device according to claim 16, wherein said bus line controller is a controller which cyclically repeatedly requests the appliance status of the domestic appliance.

19. The device according to claim 16, wherein said bus line controller is a controller which cyclically carries out the search operation.

20. The device according to claim 16, wherein said bus line controller is configured such that before receiving the appliance status of the domestic appliance, said bus line controller performs a registration procedure by which the domestic appliance obtains the unique address in the local area network by which it can be reached in the local area network.
